(19) United States
(12) Patent Application Publication
(10) Pub. No.: US 2019/0108440 A1
(43) Pub. Date: Apr. 11, 2019

(54) Information Enrichment Using Global Structure Learning

(71) Applicant: Yodlee, Inc., Redwood City, CA (US)

(72) Inventors: Atif Adib, Bangalore (IN); Deepak Chandrakant Patil, Thane (IN); Preethy Varma, Bangalore (IN); Priyanka Sawant, Bangalore (IN); Vinay Manjunath, Bangalore (IN); Om Dadaji Deshmukh, Bangalore (IN)

(21) Appl. No.: 15/728,457

(22) Filed: Oct. 9, 2017

(51) Int. Cl. G06N 3/08

(52) U.S. Cl. CPC G06N 3/08

(57) ABSTRACT

Methods, systems and computer program products implementing data enrichment using global structure learning are disclosed. An information enrichment system predicts a likely canonical name from a transaction record in which names may be shortened, or extra token(s) inserted. In a training phase, the information enrichment system determines tag patterns based on labeled and unlabeled training transaction records. The tag patterns include co-occurrence probability and sequential order of co-occurrence of tags. In a testing phase, the information enrichment system receives a test transaction record. The information enrichment system predicts a likely tag sequence from the test transaction record based on the tag patterns. The information enrichment system predicts a canonical name based on likely tag values and token composition. The information enrichment system can then enrich the test transaction record with the predicted canonical name.

### TECHNICAL FIELD

This disclosure relates generally to transaction data processing.

### BACKGROUND

Transaction data can include transaction records describing transactions between service providers and customers. The service providers can include, for example, stores, hospitals, or financial institutions. The customers can include, respectively for example, shoppers, patients, or bank customers. The transaction record describing transactions can convey to an end user nature of the transaction. For example, a merchant sales related transaction can have details such as the name of the merchant, the location of the merchant, the mode of payment and so on. Similarly, a cash withdrawal related transaction would have details such as the card details, ATM number, ATM location and so on. These details can manifest in the transaction record in a cryptically shortened format to save space and compute power. For example, “Walmart Inc.” may be shortened to “wmart” or some other form. Device generating the transaction records can vary. Accordingly, information such as a service provider's name or address may be shortened in different ways.

### SUMMARY

Techniques of data enrichment using global structure learning are disclosed. An information enrichment system predicts a likely canonical name from a transaction record in which names may be shortened or extra token(s) inserted. In a training phase, the information enrichment system determines tag patterns based on labeled and unlabeled training transaction records. The tag patterns include co-occurrence probability and sequential order of co-occurrence of tags and tokens. In a testing phase, the information enrichment system receives a test transaction record. The information enrichment system predicts a likely tag sequence from the test transaction record based on token patterns corresponding to the tag patterns. The information enrichment system predicts a canonical name based on likely tag values and token composition of the transaction description. The information enrichment system can then enrich the test transaction record with the predicted canonical name.

The features described in this specification can be implemented to achieve one or more advantages over conventional data enrichment techniques. A data enrichment system can encounter cryptically shortened transaction records as input. One important task for the data enrichment system is to analyze the cryptic description and identify tags of interest. The tags can include, for example, a name of a merchant where the transaction was processed, an identifier of a financial institution that provided an intermediary services, e.g., an online wallet service, a location of the store of interest, or a reference to an individual, e.g., money deposited in the account of Mrs. A. Conventional techniques for identifying these tags focus on identifying each tag in insolation and independent of the other tags. Accordingly, in a conventional data enrichment system, a separate machine learning classifier is trained for identifying each of the tags. Individual tag analysis may be error prone because the shortened information may be interpreted in different ways.

The disclosed techniques improve upon conventional data enrichment techniques by fundamentally shifting the individual approach of conventional data enrichment to an approach that enables joint learning and prediction of all constituent tags. The disclosed joint learning and prediction approach learns inter-dependence across various tags, the valid structural restrictions that these tags impose on each other and possible variations in the values each tag can take. The disclosed techniques improve upon the conventional techniques in multiple aspects. The disclosed techniques enable systematic cross-leveraging of information inferred from one set of tags to infer more details of the other tags. These details are generally unavailable in conventional techniques. More details can correspond to higher accuracy. The disclosed techniques provide capabilities to use the learnings and predictions from the more confident tags to the ones which are more susceptible to variations due to noise, thus reducing impact of the noise. The disclosed techniques can identify new candidate tags that the system does not know existed, improving breadth of the data enrichment. Unknown tags can be a difficult problem in conventional techniques.

The details of one or more implementations of the disclosed subject matter are set forth in the accompanying drawings and the description below. Other features, aspects and advantages of the disclosed subject matter will become apparent from the description, the drawings and the claims.

### BRIEF DESCRIPTION OF THE DRAWINGS

FIG. 1 is a block diagram illustrating an example information enrichment system.

FIG. 2 is a block diagram illustrating an example tag analyzer of an information enrichment system.

FIG. 3 is a block diagram illustrating an example name analyzer of an information enrichment system.

FIG. 4 is a flowchart illustrating an example process of canonical name identification.

FIG. 5 is a flowchart illustrating an example process of information enrichment using global structure learning.

FIG. 6 is a block diagram illustrating an example system architecture for implementing the features and operations described in reference to FIGS. 1-5

Like reference symbols in the various drawings indicate like elements.

### DETAILED DESCRIPTION

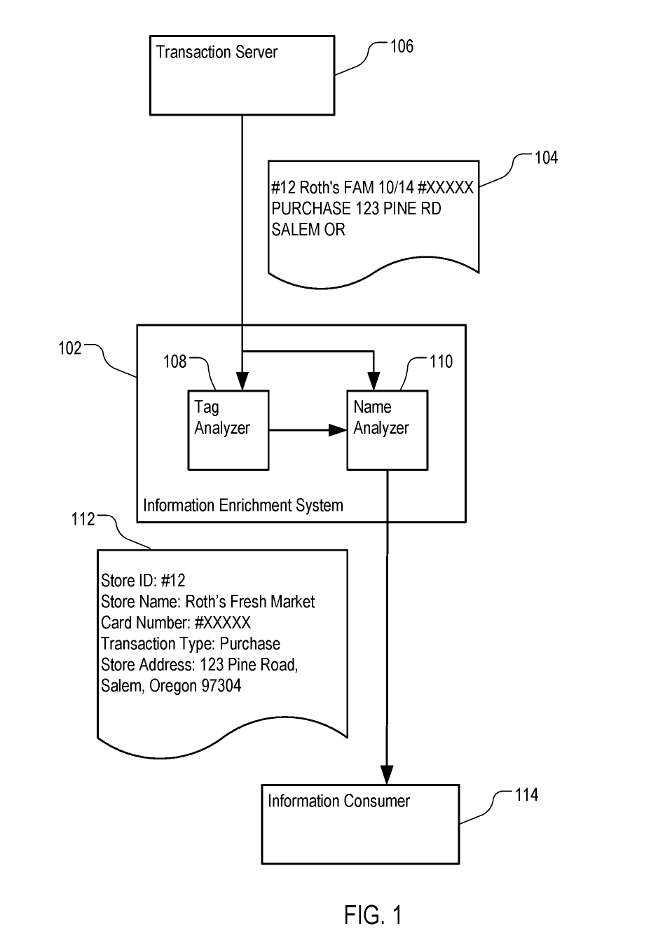

FIG. 1 is a block diagram illustrating an example information enrichment system 102. Each component of the information enrichment system 102 includes one or more processors programmed to perform information enrichment operations. The information enrichment system 102 can be implemented on one or more server computers, e.g., on a cloud-based computing platform. Each component of the information enrichment system 102 can be implemented on one or more computer processors.

The information enrichment system 102 receives transaction data 104 from a transaction server 106. The transaction data 104 includes one or more transaction records describing transactions. A transaction can be an instance of interaction between a first user and a second user (e.g., between two humans), a user and a computer (e.g., a user and a point-of-sale (PoS) device at a financial institute or a store), or a first computer and a second computer (e.g., a PoS device and a bank computer). The transaction data 104 is collected and stored by the transaction server 106.

The transaction server 106 includes one or more storage devices storing the transactional data 104. Examples of a transaction server 106 include a log server, an action data store, or a general ledger management computer of various service providers. The service providers, also referred to as merchants, can include, for example, an interactive content provider, e.g., a news provider that allows readers to posts comments, an on-line shop that allows users to buy goods or services, e.g., prescription medicine or pet food, a healthcare network that serves new and existing patients, or a financial services provider, e.g., a bank or credit card company that tracks financial transactions.

Each transaction record in the transaction data 104 can have a description of a transaction. The description can be a text string having a sequence of tokens. Each token, also referred to as a word, can be a text segment separated from other text segments by a delimiter, e.g., a space. In the example shown, a transaction record in the transaction data 104 has the following tokens, as shown in the transaction record below.

#12 Roth's FAM 10/14 #XXXXX PURCHASE 123 PINE RD SALEM OR

The tokens in this example are “#12,” “Roth's,” “FAM,” “10/14,” “#XXXXX,” “PURCHASE,” “123,” “PINE,” “RD,” “SALEM,” and “OR,” delimited by spaces. These tokens correspond to pieces of information, referred to as tags in this specification, that represent various aspects of a corresponding transaction. Each tag can be an abstraction of a token. A tag includes a description of the kind of information that a token represents. For example, the token “#12” can correspond to a tag <store-id> whereas each of the tokens “Roth's” and “FAM” can correspond to a respective tag <merchant-name>.

The information enrichment system 102 includes a tag analyzer 108. The tag analyzer 108 is configured to determine corresponding tags of the tokens. Some of the example tokens (e.g., “123” or “RD”) can be difficult for a conventional classifier to map to correct tags, e.g., <street> tags indicating street address. This is because these tokens are, among other things, generic, short and ambiguous. In contrast, the tag analyzer 108 can analyze the tokens in the transaction record as a whole, where other tokens provide a context. The tag analyzer 108, knowing likely presence of one or more tags in the transaction record, can use that knowledge to influence an expectation of other tags in the rest of the transaction record. For example, with the knowledge that “SALEM” indicates a city and “OR” indicates a State, the tag analyzer 108 can determine that the tokens immediately precede “SALEM OR” are more likely to represent a street than, say, a store ID.

In addition, operations of the tag analyzer 108 can have the effect of determining that the transaction described by the transaction record has a particular category, e.g., a “spend” category rather than a “payroll” category. A category can be a type of a transaction. Towards this effect, the tag analyzer 108 can make the determination based on one or more known indicators that signal particular types of transactions, e.g., the token “PURCHASE.” Based at least in part on the category of the transaction, the tag analyzer 108 can determine that the transaction is related to a physical store, and hence the tag analyzer 108 can expect to find some details of the location (“123 PINE RD SALEM OR” in this example). The tag analyzer 108 can use this knowledge to determine a tag sequence for the transaction record. The tag sequence can be a given series of tags, for example, <store-id> <merchant-name> <merchant-name> <date> <card-num> <payment-purpose> <street> <street> <street> <city> <state>. In the example shown, based on the knowledge from prior training, the tag analyzer 108 can determine that the tokens “123,” “PINE” and “RD” each correspond to a respective <street> tag, despite the fact that each of these tokens contains scant information and can be part of a merchant name or transaction identifier. In some implementations, the tag analyzer 108 can condense the tag sequence by merging neighboring tags that are the same as one another. For example, the tag analyzer 108 can condense the above example tag sequence into <store-id> <merchant-name> <date> <card-num> <payment-purpose> <street> <city> <state>.

The tag analyzer 108 can provide a representation of at least a portion of the tag sequence to a name analyzer 110. The name analyzer 110 is a component of the information enrichment system 102 configured to determine a canonical name for one or more tokens in a transaction record in the transaction data 104. A canonical name, also referred as a full name, is a name of an entity designated as an official name of the entity. A canonical name can be a proper name or a complete address. A canonical name can be represented as various shortened forms, or with extra tokens (e.g., “inc” or “ltd”) inserted, in different transaction records. For example, in the example shown, a canonical name for the tokens “Roth's FAM” is a merchant's full name “Roth's Fresh Market.” The name analyzer 110 can identify the canonical name from the abbreviated form “Roth's FAM” in the tokens not only from the tokens themselves, but also from the knowledge provided by the tag analyzer 108. The tag representation from the tag analyzer 108 can indicate that the tokens “Roth's FAM” correspond to a tag sequence <merchant-name> <merchant-name>. Based on the tag sequence, the name analyzer 110 can perform a lookup that is more efficient than a conventional lookup where the tag information is unavailable. This is because the knowledge that “Roth's FAM” is a shortened form of a merchant name limits the scope of search. In addition, based on the tag sequence, the name analyzer 110 can determine that the tokens corresponds to the canonical name “Roth's Fresh Market” based on machine learning, even if the name analyzer 110 never encountered the string “Roth's FAM” before.

The name analyzer 110 can perform similar operations on other tokens in the transaction record base on the tag sequence from the tag analyzer 108. For example, the name analyzer 110 can determine that the tokens “123 PINE RD SALEM OR” correspond to a canonical name, which is an address “123 Pine Road, Salem, Oreg. 97304.” From the canonical names, the information enrichment system 102 can generate enriched data 112. The enriched data 112 can include additional information explaining the transaction data 104, e.g., various fields that correspond to the tags of the transaction data 104, and corresponding canonical names. The enriched data 112 can have more structure than the original transaction data 104. Accordingly, the enriched data 112 can be tabulated and stored in a structured database. The enriched data 112 can have more formal names than the original transaction data 104. Accordingly, compared to the original transaction data 104, the enriched data 112 can be easier for a human data analyst to read and understand.

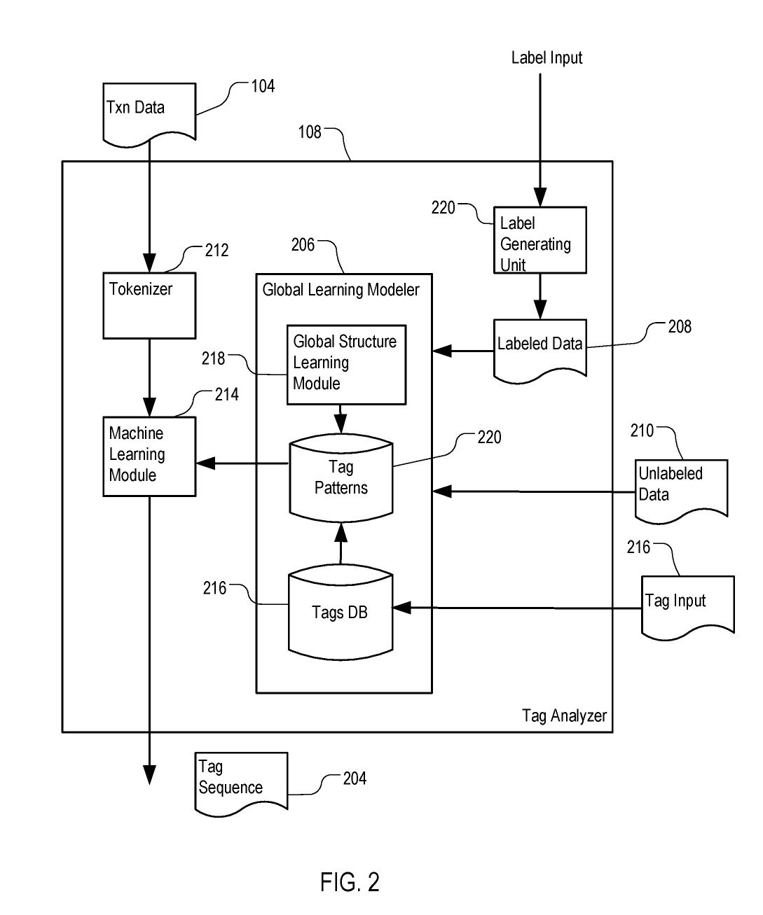

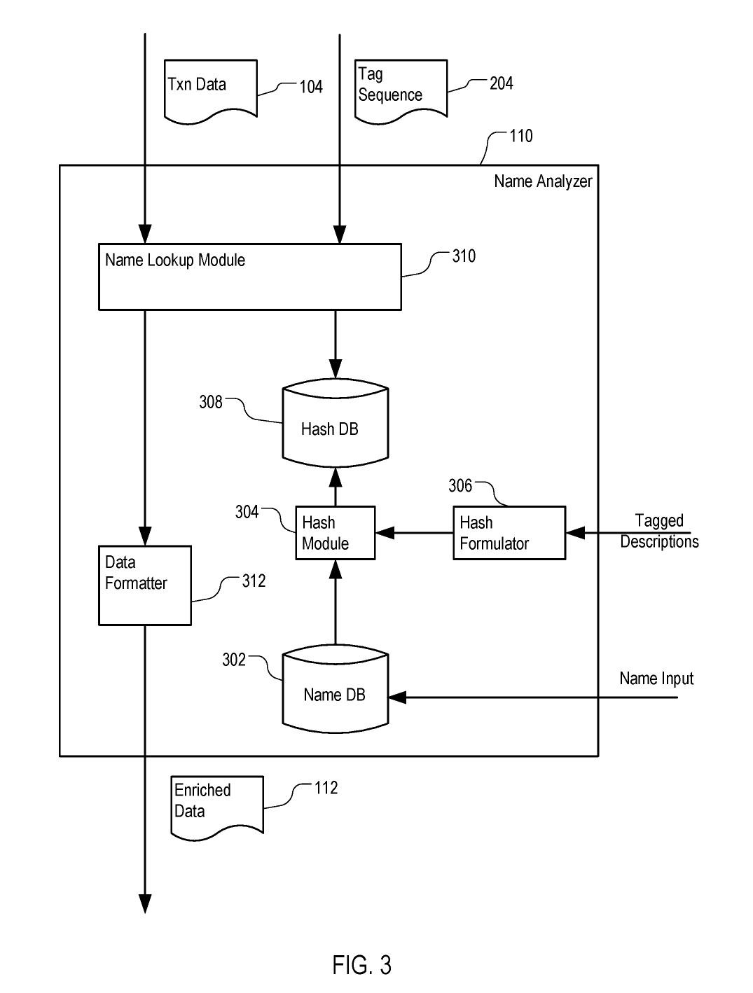

The information enrichment system 102 can provide the enriched data 112 to an information consumer 114 for storage or for further processing. The information consumer 114 can be a database system, e.g., a relational database system, that include one or more storage devices configured to store structured data. The information consumer 114 can be a data analyzer configured to aid data mining from various enriched transaction records. Additional details on components and operations of the tag analyzer 108 and the name analyzer 110 are disclosed below in reference to FIG. 2 and FIG. 3, respectively.

FIG. 2 is a block diagram illustrating an example tag analyzer 108 of an information enrichment system. The tag analyzer 108 is configured to performing operations of receiving transaction data 104 that includes one or more transaction records, automatically assigning each token in textual descriptions in the one or more transaction records a respective tag, and generating a respective tag sequence 204 for each transaction record.

The tag analyzer 108 performs the operations in multiple phases including a training phase and a prediction phase. During the training phase, a global learning modeler 206 of the tag analyzer 108 receives a sizeable amount of transaction data including descriptions of transactions. The global learning modeler 206 learns co-occurrence probability and sequential order of co-occurrence of various tags. The global learning modeler 206 also learns the various constituent tokens of each of the tags and their relative probabilities. The global learning modeler 206 can learn from labeled data 208 that has human-generated labels in a supervised setting as well as from unlabeled data 210 in an unsupervised setting.

During the prediction phase, also referred to as testing phase, a tokenizer 212 of the tag analyzer 108 determines tokens from the transaction data 104. A machine learning module 214 predicts a respective likely tag for each of the tokens. Additional details of the operations of the tag analyzer 108 in the training phase and in the prediction phase are provided below.

In the training phase, the global learning modeler 206 receives tag input 216 that specifies one or more lists of tags, e.g., <merchant-name>, <street>, among others. From these lists, the global learning modeler 206 forms an exhaustive list of tags. In some implementations, the global learning modeler 206 can suggest new likely tags based on the data the global learning modeler 206 analyzes. The global learning modeler 206 can store the tags in a tags database 218.

The tag input 216 can be provided by one or more domain experts, e.g., business analysts, reviewing a large amount, e.g., thousands, of transaction records and combine that with domain expertise to form a certain number of unique tags that cover a universe of transaction information captured across different descriptions produced by different devices under different abbreviation schemes. Example of tags stored in the tags database 216 can include <merchant-name>, <date>, <street>, <city>, <payment-purpose> and <pos-id>, among others.

The tags can include catch-all tags for unknown tokens. For example, the global learning modeler 206 can have an <other> tag that marks all tokens that have no bearing on details of a transaction. The global learning modeler 206 can have an <unidentified> tag that marks tokens that cannot be assigned to any of the existing tags. Domain experts can routinely examine tokens that are marked as <other> or <unidentified> to identify prospective tags that need to be added. The global learning modeler 206 can identify patterns in the <other> and <unidentified> tags and provide the patterns to the domain experts through a user interface. The domain experts can decide if new tags should be added based on the patterns.

A label generating unit 220 of the tag analyzer 108 can receive human input to generate the labeled data 208. The label generating unit 220 can provide a user interface or a batch operation interface to receive the human input on tags and tokens, and generate a sizeable amount of expert-tagged data. Each instance of the data is a (<description>, <tag sequence>) pair. The <description> can include an ordered list of tokens in a transaction record. The <tag sequence> is an ordered list of tags corresponding to the tokens. The <tag-sequence> also defines the key ingredients, and their order, of typical transaction types. For example, a payroll type of transaction can have an <employer> tag, an <account> tag and a <beneficiary> tag, whereas a merchant sales transaction can have a <merchant-name> tag, a <pos-id> tag, and address tags such as <street>, <city> and <state>.

The label generating unit 220 assigns a respective tag to each token in the description according to human input. The process to assign a tag includes identifying a context that the token is adding to the description. A tag is an abstraction of the corresponding token. For example, the label generating unit 220 can assign a tag <pos-id> to a unique identifier that represents a PoS machine in the description.

The global learning modeler 206 can receive the unlabeled data 210 from a description selector. The unlabeled data 210 can include transaction records without human labels. The description selector can randomly select, from a historical transaction database that stores past transaction records, unlabeled descriptions designated as structurally similar to the labeled data 208 having tags provided by human input. The description selector determines the structural similarity based on token composition of the descriptions. A token composition indicates what token and what kind of token appear where in a description.

The global learning modeler 206 can configure a global structure learning module 218. The global structure learning module 218 includes a machine learning mechanism implemented on one or more processors. The machine learning mechanism is formulated to unearth and learn patterns in the descriptions, from both the supervised and the unsupervised setting, that are indicative of the underlying tags. The global structure learning module 218 can determine one or more tag patterns, and store the tag patterns in a tag patterns data store 220. The tag patterns can include co-occurrences of tags, order of the co-occurrences, and probability of the co-occurrences. The tag patterns can indicate grammars on how tags are organized into tag sequences and frequencies of various tag sequences.

In unsupervised learning, the global structure learning module 218 learns tag patterns of likely tag sequences from unlabeled data 210. To learn the likely tag patterns from unlabeled data 210, the global structure learning module 218 can use any generative modeling techniques that also model temporal progression. In some implementations, global structure learning module 218 can use Hidden Markov Models (HMMs). The global structure learning module 218 can designate the tags as the states, and designate the sequence of tokens in the description as the observation sequence to use in the HMMs.

In the HMM framework, the global structure learning module 218 can learn multiple probabilities in order to identify the tag sequence given the input description sequence. The probability includes an initial state probability, a state transition probability and an emission/output probability. The initial state is a probability that the description starts with a particular state. The state transition probability is a probability of transitioning to a state Sj given the HMM is currently in state Si. The emission/output probability is a probability of observing a given token given that the HMM is in a particular state. In the unsupervised HMM framework, the input required is a token sequence and the list of possible states, possible tags, and allowed tag sequences.

The global structure learning module 218 can randomly initialize the three probabilities mentioned above. The global structure learning module 218 can use Baum-Welch algorithm based iterations to update these probabilities to maximize the likelihood of observing the given data. The global structure learning module 218 can apply the Baum-welch algorithm to first calculate the forward/alpha and backward probabilities for observation sequence using initialized model probabilities. Then, the global structure learning module 218 can estimate and normalize new state transitions and emission probabilities. The global structure learning module 218 use the updated probabilities in further iterations until probabilities converge.

In some implementations, instead of a random initialization, the global structure learning module 218 can initialize the HMM probabilities based on the labelled data 208. The global structure learning module 218 can further tune the HMM probabilities by utilizing the large amount of unlabeled data 210. The tag analyzer 108 can then apply the trained HMM to a test transaction record in the transaction data 104 to predict the most likely tag for each token of the test transaction record.

In supervised learning, the global structure learning module 218 learns tag patterns of likely tag sequences from labeled data 208. To learn the tag patterns from the labeled data 208, the global structure learning module 218 can apply a deep learning architecture, e.g., Recurrent Neural Networks (RNNs). The RNN architecture provides for ways to systematically incorporate outputs of previous computations into the input for current and future computations. This enables a “memory” for the data-driven learning mechanism. While the global structure learning module 218 can extend the memory to arbitrarily long past and future computations, the global structure learning module 218 can restricted the length to a small finite number to contain computational complexity. Unlike RNNs, HMNI memory is almost always restricted to just the previous state.

In some implementations, the global structure learning module 218 applies RNNs to take the tag sequence in the descriptions in the labeled data 208 as an input and predict the tag sequence as the output. The RNN setup can use a bi-directional RNN based on attention mechanism which uses Gated Recurrent Units (GRU's) as the memory cells. The bidirectional architecture helps learning the context of each tag not just from preceding tags as used in a unidirectional approach, but also from following tags. The attention mechanism allows for a weighted combination of the context to predict the next token, where the global structure learning module 218 learns the weights based on relevance of the context in predicting the current token. The RNN setup thus learns a respective vector representation for each token based on its context, learns which contexts to be given how much relative significance to predict the tag sequence for the input labelled data 208 with high accuracy. There is no need for manual feature engineering step in the process. The model also captures the appropriate level of abstraction, including token sequence and beyond, with no explicit reliance on n-gram token sequences. Compared to conventional techniques, this abstraction capability provides better generalization capabilities even when the test descriptions in the transaction data 104 contain unseen words.

The tag analyzer 108 can configure a machine learning module 214. The machine learning module 214 can be implemented on one or more processors. The machine learning module 214 predicts a sequence of tags given a description. For example, the machine learning module 214 can implement the HMI or RNN to predict a tag sequence 204 of a test description from the transaction data 104. In this specification, the term “test description” or a “test transaction record” can refer to both a description or a transaction provided for testing purposes, or an actual description or transaction record, as in contrast to “training data.”

The machine learning module 214 receives, as input, tokens in the transaction data 104 as a token sequence. The machine learning module 214 can determine a globally optimal tag sequence as predicted tags for the token sequence. A globally optimal tag sequence is a tag sequence that, considered as a whole, is a most likely tag sequence. A globally optimal tag sequence is different from locally optimal tags where particular tokens, considered individually, are likely to correspond to particular individual tags. One benefit of this global approach is that the solution leverages a combination of tags, tokens and the sequences in which they appear to predict a tag of a current token. Compared to conventional techniques, the disclosed approach reduces over-reliance on any single token. While the machine learning module 214 predicts globally optimal tag sequence, a further machine learning component can be added on top to improve the prediction accuracy for specific tags.

For example, a specific goal for a task is to predict the <merchant-name> tag with the highest accuracy. The machine learning module 214 predicts a respective tag for each token to optimize global alignment of token and tag sequences. An error analysis of the <merchant-name> prediction may show specific patterns, e.g., that the <merchant-name> tag is most often confused with a <city> tag. In such a case, the tag analyzer 108 can train a binary classifier which predicts whether a given token that has already been given a <merchant-name>tag indeed belongs to <merchant-name> tag or if that token belongs to <city> tag. In addition, the tag analyzer 108 can analyze patterns in which the <other> and <unidentified> tags occur to propose likely new tags that the human experts may have missed.

FIG. 3 is a block diagram illustrating an example name analyzer 110 of an information enrichment system. The name analyzer 110 is configured to determine a canonical name of an entity based on the tokens that was assigned a particular tag. The name analyzer 110 can be implemented on one or more processors.

The name analyzer 110 receives transaction data 104 that includes a transaction record, e.g., the example transaction record shown in FIG. 1. The name analyzer 110 receives a tag sequence 204 that corresponds to the transaction record. A description in the transaction record “Roth's FAM” corresponds to one or more <merchant-name> tags in the tag sequence 204.

The name analyzer 110 can maintain a name database 302 that stores canonical names of various entities including, for example, merchants or addresses. The name database 302 can be any form of database, e.g., a Factual™ database, that is included in or connected to the name analyzer 110. The name analyzer 110 can populate the name database 302 with a full list of the canonical names from any data source that maintains a list of merchants. The data source can include, for example, Yelp™, AggData™, Factual™, yellow pages, etc.

The name analyzer 110 includes a hash module 304. The hash module 304 is a component of the name analyzer 110 configured to hash each canonical name to a respective hash value for efficient lookup. A hash formulator 306 of the name analyzer 110 can formulate a hash function to be used by the hash module 304. The hash function is scalable, in that it should handle millions of merchant names, and accurate, in that the hash value of an abbreviated name is closest to its corresponding canonical name.

To formulate an appropriate hashing function, the hash formulator 306 can learn patterns in the abbreviations of canonical names to corresponding names-in-descriptions by analyzing a large amount of information, e.g., several hundred thousands of descriptions and their tags of interest, e.g., <merchant-name> tags. The hash function can be based on the following factors.

(a) A likelihood of a letter being dropped in the abbreviated form, which is proportional to the position of the letter in the name, e.g., the first character in the name has the lowest probability of being dropped irrespective of its identity;

(b) The probability of vowels and “s” (as in apostrophe) being dropped, where observations indicate that the vowels and s have a much higher probability of being dropped in the abbreviated version than other characters; and

(c) The abbreviated form maintains the sequence of the letters from the canonical name.

Based on the above factors, the hash formulator 306 can determine a modified Rabin-Karp hashing function to tabulate the canonical names of merchants, addresses, and so on. The hash formulator 306 can determine the hashing function as follows. For a token w, of length n, composed of characters c₁-cₙ in the form of c₁c₂. . . cₙ, an example formula to compute the hash value is given below in Equation (1).

Hash(w)=(x₁)ⁿ+(x₂)ⁿ⁻¹++(xₙ)¹, (1)

where Hash(w) is the hash value of token w, xᵢ is a score of the character cᵢ. The hash formulator 306 computes the scores x₁, x₂, . . . xₙ a based on respective probabilities in which each of the characters c₁c₂. . . cₙ is retained in a string in its reduced representation. The hash formulator 306 can choose a sufficiently large relative prime number to ensure that the collisions among merchant name hashes are reduced. The hash formulator 306 provides the formula to the hash module 304.

In a training phase, the hash module 304 computes the hash values of the canonical names of all entities, e.g., merchants and addresses, in the name database 302. The hash module 304 stores the hash values in a table in a hash database 308.

During a prediction phase, a name lookup module 310 computes hash value(s) of token or token sequence corresponding to a particular tag of interest, e.g., the <merchant-name> tag. Assume that this value is μ. The name lookup module 310 determines a short list of likely candidates. The short list includes selected canonical names corresponding to the tag of interest, e.g., merchant names, whose hash values are between a pre-defined threshold τ of μ. The name lookup module 310 then compare each of these candidate names with the token or token sequence using a modified Levenshtein distance measure. The name lookup module 310 chooses a canonical name that has the lowest distance measure and below a pre-defined value ∂ as the final canonical name, e.g., the full merchant name, corresponding to the token or token sequence. If none of the candidate names in the short list meet this requirement, the name lookup module 310 increases the threshold τ and repeats the process iteratively until a valid canonical name is found or a time-out, e.g., 500 milliseconds, occurs.

The name lookup module 310 can provide the tokens, tags, and the canonical name to an optional data formatter 312 of the name analyzer 110. The data formatter 312 can tabulate the information and generate enriched data 112. The data formatter 312 can provide the enriched data 112 to an information consumer.

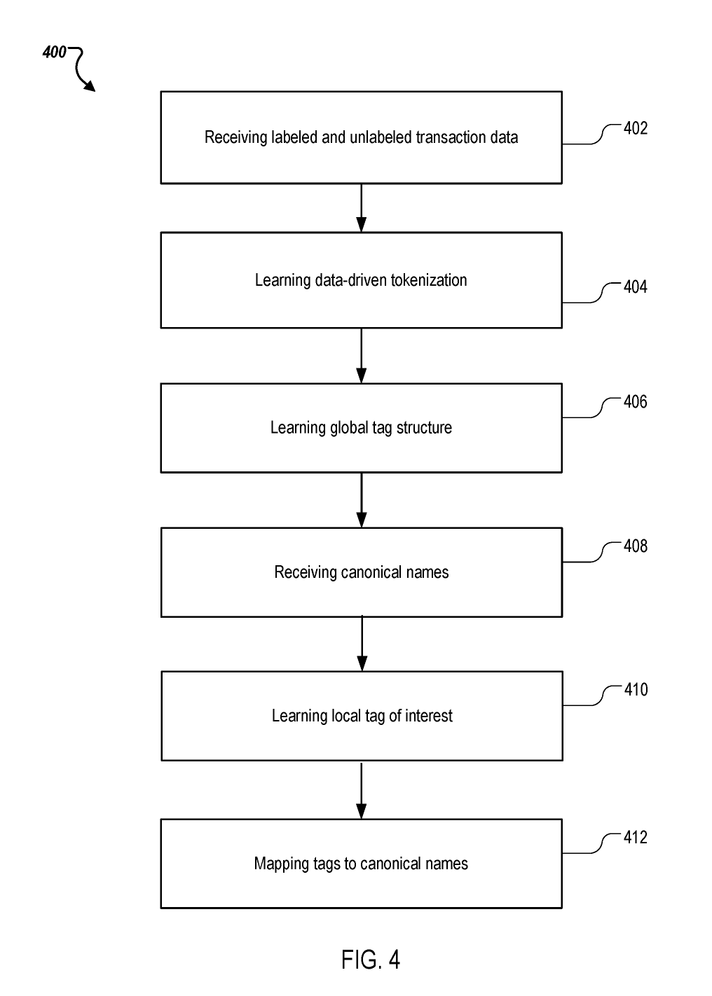

FIG. 4 is a flowchart illustrating an example process 400 of canonical name identification. The process 400 can be performed by a system including one or more processors, e.g., the information enrichment system 102 of FIG. 1. The process 400 can include a training phase and a testing phase.

In the training phase, the system receives (402), as training data, labeled transaction records and unlabeled transaction records. The transaction records can include descriptions of transactions and optionally, metadata. The labeled transaction records can be associated with tag sequences corresponding to tokens in the transaction records.

The system learns (404) data-driven tokenization. Learning data-driven tokenization includes learning how to normalize the received transaction records. For example, the system normalizes an input “Dr.” into “dr” and normalizes an input “10/14” into “<digits> <special character> <digits>.”

The system learns (406) global tag structure. Learning the global tag structure includes configuring machine learning mechanisms for classifying tokens in transaction records and for predicting tags from tokens. The learning can include configuring an HMM from the unlabeled data or labeled data and configuring an RNN from the labeled data. At this stage, the system determines tag patterns. The tag patterns include probability of co-occurrence of tokens and order of the co-occurrence.

The system receives (408) canonical names from various sources, e.g., third party business entity name and location databases. The canonical names can include, for example, full merchant names and addresses. The system hashes the received canonical names and stores the hash values in a hash value data store.

In the testing phase, the system predicts one or more canonical names from a test transaction record. The system learns (410) a local tag of interest from the test transaction record. The system learns the local tag of interest by feeding the test transaction record to the machine learning mechanisms previously trained.

The system maps (412) tags to the canonical names. Mapping the tags to the canonical names can be based on hash values of tokens in the test transaction record and hash values of canonical names of the tag of interest. The system enriches the test transaction record with the canonical names and provides the enriched transaction record to an information consumer, e.g., a non-transitory storage device or one or more computers, for storage or for further processing.

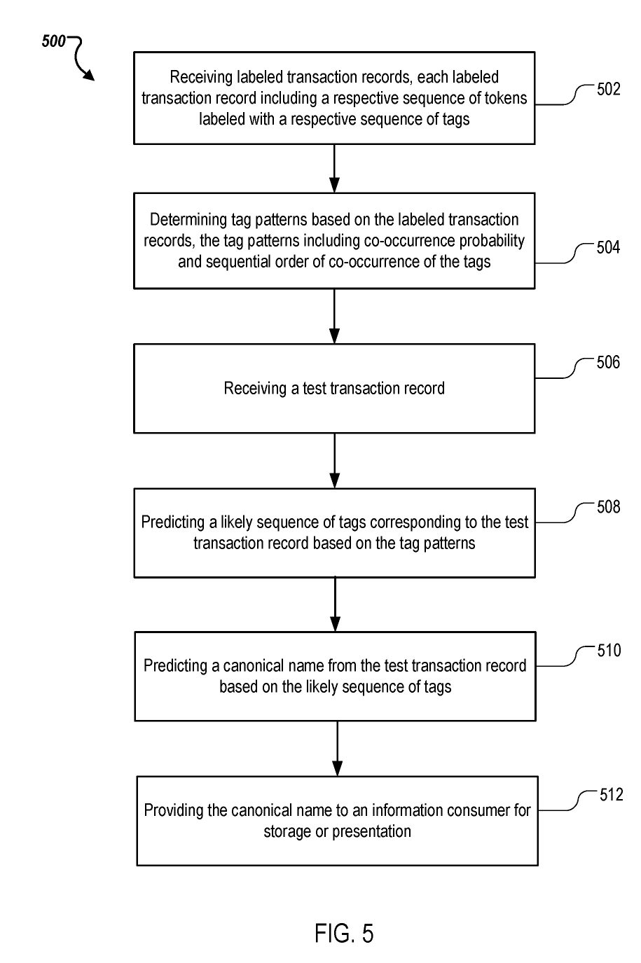

FIG. 5 is a flowcharts illustrating an example process 500 of information enrichment using global structure learning. The process 500 can be performed by a system including one or more processors, e.g., the information enrichment system 102 of FIG. 1.

The system receives (502) labeled transaction records as training data. Each labeled transaction record includes a respective sequence of tokens labeled with a respective sequence of tags. Each tag is an abstraction of a corresponding token. In some implementations, the system also receives unlabeled transaction records. Each unlabeled transaction record includes a respective sequence of tokens without being labeled with sequences of tags.

The system determines (504) tag patterns based on the labeled transaction records, the tag patterns including co-occurrence probability and sequential order of co-occurrence of the tags. Determining the tag patterns based on the labeled transaction records can include training an RNN. The RNN receives the sequences of tokens and the sequences of tags in the labeled transaction records as input and provides the tag patterns as output.

Alternatively or additionally, determining the tag patterns can be based on the unlabeled transaction records. Determining the tag patterns based on the unlabeled transaction records can include training an HMM. For the HMM, tags are designated as states in the HMM, and the sequence of tokens in the unlabeled transaction records are designated as observation sequences in the HMM.

The system receives (506) a test transaction record. The test transaction record can be a transaction record received in real time. The test transaction record can include tokens that the system has not encountered before.

The system predicts (508) a likely sequence of tags corresponding to the test transaction record based on the tag patterns. Predicting the likely sequence of tags corresponding to the test transaction record based on the patterns can include the following operations. The system provides the test transaction record as input to a machine learning module of the system that includes at least one of a trained MINI or a trained RNN. The machine learning module can determine, from the test transaction record, a globally optimal tag sequence that corresponds to the test transaction record. The machine learning module can designate the globally optimal tag sequence as the likely sequence of tags.

The system predicts (510) a canonical name from the test transaction record based on a likely sequence of tokens corresponding to the likely sequence of tags. Predicting the canonical name can include the following operations. A name analyzer of the system determines that one or more tokens in the test transaction record correspond to a particular tag, e.g., <merchant-name>. The name analyzer compares a hash value of the one or more tokens and hash values of canonical names corresponding to the particular tag. The hash values of the canonical names are previously calculated and are stored in a hash database. Based on the comparing, the name analyzer determines a short list of canonical names. The name analyzer can determine a respective string likelihood distance between the one or more tokens and each canonical name in the short list. The name analyzer can designate a canonical name in the short list that corresponds to a shortest string likelihood distance as the predicted canonical name. In some implementations, the hash value is determined based on a modified Rabin-Karp hashing function. The string likelihood distance is a modified Levenshtein distance.

The system provides (512) the canonical name to an information consumer for storage or presentation as enriched transaction data. The information consumer can include a storage device configured to store the enriched transaction data, one or more computers configured to process the enriched transaction data, e.g., to perform data mining, or one or more display devices configured to present the enriched transaction data.

### Exemplary System Architecture

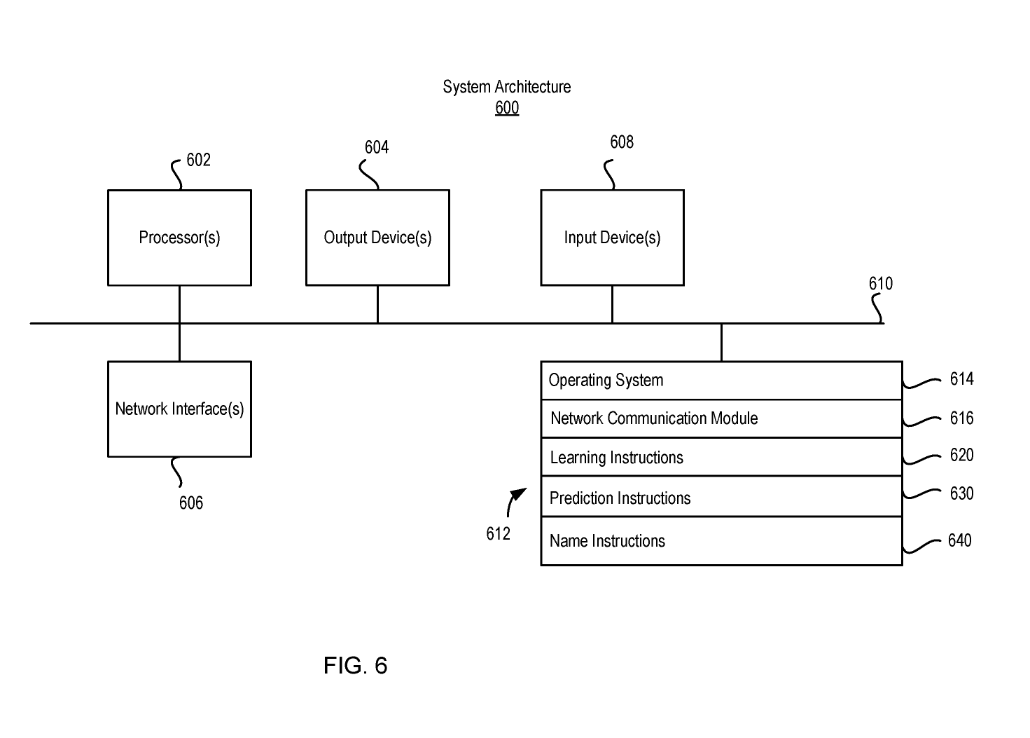

FIG. 6 is a block diagram of an example system architecture for implementing the systems and processes of FIGS. 1-5. Other architectures are possible, including architectures with more or fewer components. In some implementations, architecture 600 includes one or more processors 602 (e.g., dual-core Intel® Xeon® Processors), one or more output devices 604 (e.g., LCD), one or more network interfaces 606, one or more input devices 608 (e.g., mouse, keyboard, touch-sensitive display) and one or more computer-readable mediums 612 (e.g., RAM, ROM, SDRAM, hard disk, optical disk, flash memory, etc.). These components can exchange communications and data over one or more communication channels 610 (e.g., buses), which can utilize various hardware and software for facilitating the transfer of data and control signals between components.

The term “computer-readable medium” refers to a medium that participates in providing instructions to processor 602 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 612 can further include operating system 614 (e.g., a Linux® operating system), network communication module 616, training instructions 620, prediction instructions 630 and name instructions 640. Operating system 614 can be multi-user, multiprocessing, multitasking, multithreading, real time, etc. Operating system 614 performs basic tasks, including but not limited to: recognizing input from and providing output to devices 606, 608; keeping track and managing files and directories on computer-readable mediums 612 (e.g., memory or a storage device); controlling peripheral devices; and managing traffic on the one or more communication channels 610. Network communications module 616 includes various components for establishing and maintaining network connections (e.g., software for implementing communication protocols, such as TCP/IP, HTTP, etc.).

Training instructions 620 can include computer instructions that, when executed, cause processor 602 to perform operations of the global learning modeler 206 of FIG. 2, including training an HMM, an RNN or both, from labeled and unlabeled transaction data. Prediction instructions 630 can include computer instructions that, when executed, cause processor 602 to predict a likely sequence of tags corresponding to a test transaction record. Name instructions 640 can include computer instructions that, when executed, cause processor 602 to perform the operations of the name analyzer 110 of FIG. 1, including determining one or more canonical names corresponding to the test transaction record and providing the one or more canonical names to an information consumer.

Architecture 600 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
receiving labeled transaction records, each labeled transaction record including a respective sequence of tokens labeled with a respective sequence of tags, each tag being an abstraction of a corresponding token;
determining tag patterns based on the labeled transaction records, the tag patterns including co-occurrence probability and sequential order of co-occurrence of the tags;
receiving a test transaction record;
predicting a likely sequence of tags corresponding to the test transaction record based on the tag patterns;
predicting a canonical name from the test transaction record based on composition of a likely sequence of tokens corresponding to the likely sequence of tags; and
providing the canonical name to an information consumer for storage or presentation, wherein the method is performed by one or more processors.

2. The method of claim 1, further comprising receiving unlabeled transaction records, each unlabeled transaction record including a respective sequence of tokens without being labeled with sequences of tags, wherein determining the tag patterns is further based on the unlabeled transaction records.

3. The method of claim 2, wherein determining the tag patterns based on the unlabeled transaction records includes training a Hidden Markov Model (HMM), wherein the tags are designated as states in the HMM, and the sequence of tokens in the unlabeled transaction records are designated as observation sequences in the HMM.

4. The method of claim 1, wherein determining the tag patterns based on the labeled transaction records includes training a Recurrent Neural Network (RNN), wherein the RNN receives the sequences of tokens and the sequences of tags in the labeled transaction records as input and provides the tag patterns as output.

5. The method of claim 1, wherein predicting the likely sequence of tags corresponding to the test transaction record based on the patterns comprises:
providing the test transaction record as input to a machine learning module that includes at least one of a trained Hidden Markov Model or a trained Recurrent Neural Network;
determining, by the machine learning module, a globally optimal tag sequence that corresponds to the test transaction record; and
designating the globally optimal tag sequence as the likely sequence of tags.

6. The method of claim 1, wherein predicting a canonical name from the test transaction record comprises:
determining that one or more tokens in the test transaction record correspond to a particular tag;
comparing a hash value of the one or more tokens and hash values of canonical names corresponding to the particular tag, the hash values of the canonical names being stored in a hash database;
determining a short list of canonical names based on the comparing;
determining a respective string likelihood distance between the one or more tokens and each canonical name in the short list;
designating a canonical name in the short list that corresponds to a shortest string likelihood distance as the predicted canonical name.

7. The method of claim 6, wherein the hash value is determined based on a modified Rabin-Karp hashing function, and the string likelihood distance is a modified Levenshtein distance.

8. A system comprising:
one or more computers; and
one or more storage devices which store instructions that are operable, when executed by the one or more computers, to cause the one or more computers to perform operations comprising:
receiving labeled transaction records, each labeled transaction record including a respective sequence of tokens labeled with a respective sequence of tags, each tag being an abstraction of a corresponding token;
determining tag patterns based on the labeled transaction records, the tag patterns including co-occurrence probability and sequential order of co-occurrence of the tags;
receiving a test transaction record;
predicting a likely sequence of tags corresponding to the test transaction record based on the tag patterns;
predicting a canonical name from the test transaction record based on composition of a likely sequence of tokens corresponding to the likely sequence of tags; and
providing the canonical name to an information consumer for storage or presentation.

9. The system of claim 8, the operations further comprising receiving unlabeled transaction records, each unlabeled transaction record including a respective sequence of tokens without being labeled with sequences of tags, wherein determining the tag patterns is further based on the unlabeled transaction records.

10. The system of claim 9, wherein determining the tag patterns based on the unlabeled transaction records includes training a Hidden Markov Model (HMM), wherein the tags are designated as states in the HMM, and the sequence of tokens in the unlabeled transaction records are designated as observation sequences in the HMM.

11. The system of claim 8, wherein determining the tag patterns based on the labeled transaction records includes training a Recurrent Neural Network (RNN), wherein the RNN receives the sequences of tokens and the sequences of tags in the labeled transaction records as input and provides the tag patterns as output.

12. The system of claim 8, wherein predicting the likely sequence of tags corresponding to the test transaction record based on the patterns comprises:
providing the test transaction record as input to a machine learning module that includes at least one of a trained Hidden Markov Model or a trained Recurrent Neural Network;
determining, by the machine learning module, a globally optimal tag sequence that corresponds to the test transaction record; and
designating the globally optimal tag sequence as the likely sequence of tags.

13. The system of claim 8, wherein predicting a canonical name from the test transaction record comprises:
determining that one or more tokens in the test transaction record correspond to a particular tag;
comparing a hash value of the one or more tokens and hash values of canonical names corresponding to the particular tag, the hash values of the canonical names being stored in a hash database;
determining a short list of canonical names based on the comparing;
determining a respective string likelihood distance between the one or more tokens and each canonical name in the short list;
designating a canonical name in the short list that corresponds to a shortest string likelihood distance as the predicted canonical name.

14. The system of claim 13, wherein the hash value is determined based on a modified Rabin-Karp hashing function, and the string likelihood distance is a modified Levenshtein distance.

15. One or more non-transitory storage devices storing instructions that are operable, when executed by one or more computers, to cause the one or more computers to perform operations comprising:
receiving labeled transaction records, each labeled transaction record including a respective sequence of tokens labeled with a respective sequence of tags, each tag being an abstraction of a corresponding token;
determining tag patterns based on the labeled transaction records, the tag patterns including co-occurrence probability and sequential order of co-occurrence of the tags;
receiving a test transaction record;
predicting a likely sequence of tags corresponding to the test transaction record based on the tag patterns;
predicting a canonical name from the test transaction record based on composition of a likely sequence of tokens corresponding to the likely sequence of tags; and
providing the canonical name to an information consumer for storage or presentation.

16. The one or more non-transitory storage devices of claim 15, the operations further comprising receiving unlabeled transaction records, each unlabeled transaction record including a respective sequence of tokens without being labeled with sequences of tags, wherein determining the tag patterns is further based on the unlabeled transaction records.

17. The one or more non-transitory storage devices of claim 16, wherein determining the tag patterns based on the unlabeled transaction records includes training a Hidden Markov Model (HMM), wherein the tags are designated as states in the HMM, and the sequence of tokens in the unlabeled transaction records are designated as observation sequences in the HMM.

18. The one or more non-transitory storage devices of claim 15, wherein determining the tag patterns based on the labeled transaction records includes training a Recurrent Neural Network (RNN), wherein the RNN receives the sequences of tokens and the sequences of tags in the labeled transaction records as input and provides the tag patterns as output.

19. The one or more non-transitory storage devices of claim 15, wherein predicting the likely sequence of tags corresponding to the test transaction record based on the patterns comprises:
providing the test transaction record as input to a machine learning module that includes at least one of a trained Hidden Markov Model or a trained Recurrent Neural Network;
determining, by the machine learning module, a globally optimal tag sequence that corresponds to the test transaction record; and
designating the globally optimal tag sequence as the likely sequence of tags.

20. The one or more non-transitory storage devices of claim 15, wherein predicting a canonical name from the test transaction record comprises:
determining that one or more tokens in the test transaction record correspond to a particular tag;
comparing a hash value of the one or more tokens and hash values of canonical names corresponding to the particular tag, the hash values of the canonical names being stored in a hash database;
determining a short list of canonical names based on the comparing;
determining a respective string likelihood distance between the one or more tokens and each canonical name in the short list;
designating a canonical name in the short list that corresponds to a shortest string likelihood distance as the predicted canonical name.
